(19) United States
(12) Patent Application Publication
(10) Pub. No.: US 2008/0267687 A1
(43) Pub. Date: Oct. 30, 2008

(54) Writing instrument with one press-release operating member

(76) Inventor: Thomas Donald Blair, Battle Creek, MI (US)

Correspondence Address: Thomas D. Blair, 60 Orchard Place, Battle Creek, MI, 49017, US

(21) Appl. No.: 11/789,112

(22) Filed: Apr. 24, 2007

(51) Int. Cl. B43K 5/16

(52) U.S. Cl. 401/103

(57) ABSTRACT

A writing instrument includes one press-release operating member, which extends and instantly retracts the writing element when depressed and released, respectively, by the user's fingers.

### BACKGROUND OF THE INVENTION

1. Technical Field of the Invention

This invention pertains to writing instruments with a mechanism to extend or retract a writing element.

2. Description of the Prior Art

Three common objectives of much prior art, especially ballpoint pens, have been to prevent inadvertent exposure of the writing element, ease of use and economy of manufacture. Retractable writing instruments of the prior art or currently on the market employ both multiple operating members and finger-hand movements to fully operate (i.e., movements to extend, employ in the writing position and retract the writing element). Examples of such writing instruments include: push-button (Johmann U.S. Pat. No. 2,905,147); side-knockable (Sakaoka U.S. Pub. No. US2004/0037610 A1); screwable (U.S. Pat. to Koeln et al. U.S. Pat. No. 4,786,197); biasing (U.S. Pat. to Hashimoto et al. U.S. Pat. No. 6,095,706); inertial weight (Kageyama et al. U.S. Pat. No. 4,669,904) and magnetic (Bruhn et al., U.S. Pat. No. 4,729,685).

In reference to U.S. Pat. to Garganese U.S. Pat. No. 4,381,158, an operating mechanism comprising six members requires two separate movements of inward pressure by the fingers to fully operate the writing element. If the user neglects to press inward to retract the writing element immediately after usage, the writing element will be exposed and possibly mark clothing or other unintended surface in the same manner as other retractable ballpoint pens.

In addition, U.S. Pat. to Bean U.S. Pat. No. 4,475,834 describes an operating mechanism in which four operating members (i.e., spring, flexible barrel casing, internal fluid, bellows) are actuated by depressing the barrel to hydraulically project the writing element against the retracting force of a spring. Although possibly simpler to operate than prior art, it is nonetheless mechanically complex to manufacture, particularly with the introduction of a fluid member that, under pressure, could leak onto clothing similarly to the inadvertent marking from an exposed writing element.

Beyond the multiple components and handling positions of the above examples, this invention comprises one operational member that fully actuates the writing element to provide a writing instrument that is easy to use, economical to manufacture and instantly retracts the writing element after each use to protect clothing and other surfaces from inadvertent marking.

### SUMMARY OF THE INVENTION

The objectives of this invention are to provide a writing instrument that is actuated by one operating member, or spindle of resilient bands, to extend, employ the writing position and instantly retract the writing element after each use; simple and economical to make and easy to use.

In order to accomplish these objectives, there is provided according to this invention a novel and improved writing instrument having a barrel of longitudinal axis with an open front end, closed rear end and openings near the front end. A writing element, with an attached annular sleeve near its front end, is disposed in the barrel for undergoing forward and rearward sliding movement along the longitudinal axis. An operating member, or spindle of resilient bands, is disposed in the barrel for undergoing transverse-axial movement along the longitudinal axis. The base of the operating member is fixed to an interior rearward ledge in the barrel and the front ends of the resilient bands are grasped onto the writing element about the groove of an annular sleeve. The apex of the resilient bands at rest are located central to the openings in the front barrel surface, and an inward force by the fingers through the openings presses the bands until they abut the surface of the writing element such that the writing element is extended into the writing position. When the fingers release pressure on the resilient bands as they pass outward through the openings, the resilient bands undergo axial-transverse movement to instantly retract the writing element from the front end of the barrel.

Additional features and advantages of this invention will become apparent in the following description and accompanying drawings.

### BRIEF DESCRIPTION OF THE DRAWINGS

The above summary and later description of the preferred embodiment of this invention will be clearer when read in conjunction with the accompanying drawings. In the drawings:

FIG. 1 is a partial perspective view of this invention;

FIG. 2 is a partial cross-sectional view of this invention with the operating member at rest and the writing element in the retracted position;

FIG. 3 is a partial cross-sectional view of this invention with the operating member depressed and the writing element in the extended position; and

FIG. 4 is an exploded perspective view of this invention.

### DETAILED DESCRIPTION OF THE PREFERRED EMBODIMENT

While this invention can be embodied in many different forms with various materials, this specification and the accompanying drawings show a preferred form that is not intended to limit the embodiments herein described.

Descriptive terminology (e.g., “spindle,” “band,” “resilient”) employed herein is for convenience only and not intended to be limiting.

The preferred embodiment of this invention is a retractable writing instrument (e.g., ballpoint pen); however, those of ordinary skill in the art will know and appreciate that this invention is not limited to the preferred embodiment and is also adaptable to a refillable, as well as single-use, type of retractable writing instrument.

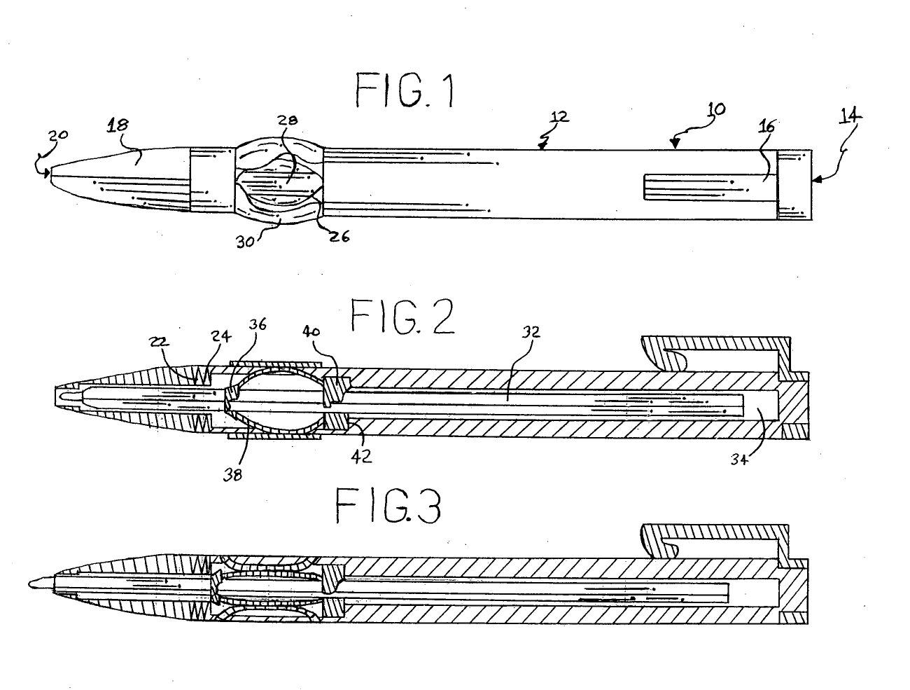

Referring now to FIGS. 1 and 2, the writing instrument embodied in this invention is generally shown at 10. It includes a barrel that is tubular and generally indicated at 12 with a closed rear end 14 on which a conventional clip 16 is mounted. At the front of the barrel, a ferrule 18 has a front opening 20 and flares outward into a rear end equal in outer diameter to that of the barrel front end it joins, with an external thread 22 that engages an internal barrel thread 24. As with the barrel, the ferrule and the operating member, or spindle of resilient bands, described below may be fabricated of metal, plastic or other suitable material. Near the front of the barrel is an opening 26, which, together with two like openings equally spaced on the same axis around the barrel surface, provides finger access to the apexes of three underlying resilient bands (one of which is at 28) of the operating member. In one variation, a thin annular grip 30 covers the openings to provide more gripping surface for the fingers and to protect the underlying resilient bands and barrel interior during actuation of the writing element. The annular grip is deformable by the user's fingers and preferably of elastomeric composition. One of ordinary skill in the art will know and appreciate that the annular grip may also be shaped to complement the outline of the openings. The structure and function of the operating member will be further described below.

The rigid writing element 32 is shown in FIGS. 2 and 3 extended and retracted, respectively. It is located on the longitudinal axis of the barrel, and near the rear of the barrel in the retracted position within a channel 34 whose diameter is suitable to accommodate free movement of the writing element. Fixed to the writing element is an annular sleeve 36 with an outward and rearward taper that forms a groove 38 within which are grasped the front ends of the resilient bands. One of ordinary skill in the art will know and appreciate that the annular sleeve and groove may also be formed as an integral part of the writing element.

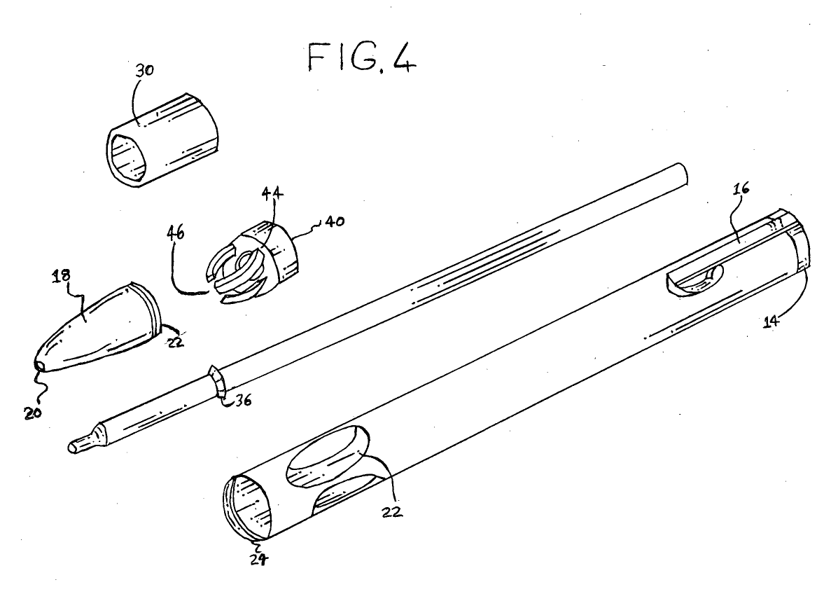

The operating member, shown more clearly in FIG. 4, is fixed at its cylindrical base 40 to an inner annular ledge 42 of the barrel, and has a central opening to support the writing element and allow it to freely slide through. The front surface of the operating member base has three equally spaced resilient bands about the circumference of the central opening (one is shown at 44), which can be fixed (e.g., glued, fused) to the cylindrical base or captive within slots within the base where they may move about freely in response to their actuation of the writing element. One of ordinary skill in the art will know and appreciate that the operating member base and resilient bands may also be manufactured with variability as to the number of resilient bands. The junction 46 between the front ends of the three resilient bands is sufficient in dimension to securely grasp the writing element about and within the annular sleeve groove during full operation. The apexes of the arcs formed by the resilient bands at rest (i.e., retracted position of the writing element) are located central to the barrel openings and at or below the barrel exterior surface.

In using the writing instrument 10 and its components assembled as shown in FIG. 2, the user extends the writing element to the writing position by depressing through the grip the resilient bands with the fingers through the barrel openings until the resilient bands have been extended to abut the surface of the writing element. As the inward force is applied, the resilient bands respond by expanding in length and, grasped onto the annular sleeve groove of the writing element, extend forward until the writing element protrudes beyond the ferrule opening. The surface of the writing element adds support for the user's fingers in the writing position and stops the resilient bands from flexing beyond the point from which they cannot reflex to their original resting position.

Now, with the writing instrument in the writing position as shown in FIG. 3, retracting the writing element is effected by a reciprocal movement of the fingers on the grip; that is, the fingers release sufficient surface pressure on the resilient bands to enable the resilient bands to reflex to their original position at rest. In this actuation, the front ends of the resilient bands, which are securely grasped to the writing element annular sleeve groove, pull the writing element rearward until the resilient bands return to their position at rest, thereby moving the writing element to a retracted position within the ferrule or front end of the barrel.

I claim:

1. A writing instrument comprising a tubular barrel with closed rear end and open front end; a writing element longitudinally located in said barrel that is extendable and retractable through said open front end; operating means situated in said barrel to extend said writing element through said open front end to a writing position and retract said writing element to a retracted position within front end of said barrel; openings in said barrel front end; an annular grip covering said openings; said operating means including an operating member beneath said openings; said operating member including resilient bands having apexes centered within said openings at or below said barrel exterior surface; said operating member resilient bands fixed to a rearward operating member base; said operating member base fixed to an annular ledge in said barrel and having a center opening to support movement of said writing element, and said resilient bands grasped forward about annular sleeve groove fixed to said writing element; whereon to extend said writing element, pressure on said resilient bands projected inwardly through said grip and openings causes said writing element to extend forward until said resilient bands abut said writing element surface to extend said writing element longitudinally through said open front end; or to retract said writing element to a retracted position within said barrel front end, said operating member having said resilient bands extended between said operating member base and said groove of said annular sleeve, wherein said writing element is in a writing position, wherein a reciprocal outward release of pressure on said resilient bands causes said grip and said resilient bands to reflex to said location beneath said barrel front openings, causes said writing element to retract rearward longitudinally into said barrel front end to a retracted position.
